(19) United States
(12) Patent Application Publication
(10) Pub. No.: US 2023/0147518 A1
(43) Pub. Date: May 11, 2023

(54) SUSCEPTOR

(71) Applicant: Nicoventures Trading Limited, London (GB)

(72) Inventors: Patrick MOLONEY, London (GB); Anton KORUS, London (GB)

(21) Appl. No.: 17/792,444

(22) PCT Filed: Jan. 15, 2021
(86) PCT No.: PCT/EP2021/050812

§ 371 Date: Jul. 13, 2022

(30) Foreign Application Priority Data
Jan. 16, 2020 (GB) 2000686.2

(51) Int. Cl. A24F 40/465; A24D 1/20; A24C 5/01; A24F 40/20; H05B 6/10

(52) U.S. Cl. CPC A24F 40/465; A24D 1/20; A24C 5/01; A24F 40/20; H05B 6/105

(57) ABSTRACT

Provided herein is a susceptor for at least partially embedding within an object for use with anon-combustible aerosol provision device, the object comprising aerosol-generating material. The susceptor is shaped to provide a lower resistance to movement of the susceptor into the object in a first direction than out of the object in a second direction opposite to the first direction.

The present application is a National Phase entry of PCT Application No. PCT/EP2021/050812, filed Jan. 15, 2021, which claims priority from GB Patent Application No. 2000686.2, filed Jan. 16, 2020, which are hereby fully incorporated herein by reference.

### TECHNICAL FIELD

The present disclosure relates to a susceptor for embedding within an object for use with a non-combustible aerosol provision device, to a consumable for use with a non-combustible aerosol provision device, to a method of manufacturing a consumable for use with a non-combustible aerosol provision device, and to a non-combustible aerosol provision system.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

According to a first aspect of the present disclosure, there is provided a susceptor for at least partially embedding within an object for use with a non-combustible aerosol provision system, the object comprising aerosol-generating material; wherein the susceptor is shaped to provide a lower resistance to movement of the susceptor into the object in a first direction than out of the object in a second direction opposite to the first direction.

Optionally, the susceptor comprises a body and at least one projection extending from the body; wherein the at least one projection is arranged to engage with the object when the susceptor is embedded within the object to provide a resistance to movement of the susceptor within the object; and wherein the at least one projection is arranged to provide a lower resistance to movement of the susceptor into the object in the first direction than out of the object in the second direction.

Optionally, the or each projection comprises a barb.

Optionally, the body is heatable by penetration with a varying magnetic field.

Optionally, the or each projection is heatable by penetration with a varying magnetic field.

Optionally, the body is integrally formed with the or each projection.

Optionally, the at least one projection comprises plural projections, wherein at least a first of the plural projections extends from a first side of the body, and wherein at least a second of the plural projections extends from a second side of the body opposite from the first side of the body.

According to a second aspect of the present disclosure, there is provided a method of manufacturing a consumable for use with a non-combustible aerosol provision device, the method comprising: providing an object and the susceptor according to the first aspect of the present disclosure, wherein the object comprises aerosol-generating material; and moving the susceptor and the object relative to each other so that the susceptor is at least partially embedded within the object in the first direction.

Optionally, the object comprises a rod comprising the aerosol-generating material and a wrapper that is wrapped around the aerosol-generating material.

Optionally, the moving comprises pushing the susceptor into the object in the first direction.

Optionally, the moving comprises moving the susceptor and the object relative to each other so that the susceptor is at least partially embedded within the aerosol-generating material in the first direction.

According to a third aspect of the present disclosure, there is provided a consumable for use with a non-combustible aerosol provision device, the consumable comprising an object comprising aerosol-generating material, and the susceptor according to the first aspect of the present disclosure at least partially embedded in the object.

Optionally, the susceptor is at least partially embedded in the aerosol-generating material.

Optionally, the susceptor is shaped to provide a lower resistance to movement of the susceptor into the aerosol-generating material of the object in a first direction than out of the aerosol-generating material of the object in a second direction opposite to the first direction.

According to a fourth aspect of the present disclosure, there is provided a consumable for use with a non-combustible aerosol provision device, the consumable comprising: aerosol-generating material, and a susceptor that is at least partially embedded in the aerosol-generating material so that a first portion of the aerosol-generating material is axially adjacent the susceptor; wherein a density of the first portion of the aerosol-generating material and/or a density of a second portion of the aerosol-generating material radially adjacent the susceptor is greater than a density of a third portion of the aerosol-generating material radially adjacent the first portion of the aerosol generating-material.

Optionally, the density of the first portion of the aerosol-generating material and the density of the second portion of the aerosol-generating material are greater than the density of the third portion of the aerosol-generating material.

Optionally, an axial dimension of the susceptor is less than a parallel dimension of the aerosol-generating material.

Optionally, the susceptor is fully embedded in the aerosol-generating material.

Optionally, the susceptor is substantially coaxial with a central axis of the consumable.

According to a fifth aspect of the present disclosure, there is provided a method of manufacturing a consumable for use with a non-combustible aerosol provision device, the method comprising: providing an object comprising aerosol-generating material, the aerosol-generating material comprising: a first portion of aerosol-generating material, a second portion of aerosol-generating material and a third portion of aerosol-generating material, wherein a density of the first portion of the aerosol-generating material and/or a density of the second portion of the aerosol-generating material is greater than a density of the third portion of the aerosol-generating material; and embedding a susceptor at least partially in the aerosol-generating material so that the first portion of the aerosol-generating material is axially adjacent the susceptor, the second portion of the aerosol-generating material is radially adjacent the susceptor and the third portion of the aerosol-generating material is radially adjacent the first portion of the aerosol generating-material.

According to a sixth aspect of the present disclosure, there is provided a consumable manufactured according to the fifth aspect of the present disclosure.

Optionally, the susceptor of the consumable of the fourth aspect of the present disclosure or the sixth aspect of the present disclosure is the susceptor according to the first aspect of the present disclosure.

According to a seventh aspect of the present disclosure, there is provided a non-combustible aerosol provision system, comprising: the consumable according to the third aspect of the present disclosure, the fourth aspect of the present disclosure or the sixth aspect of the present disclosure; and a non-combustible aerosol provision device for causing heating of the aerosol-generating material of the consumable to volatilize at least one component of the aerosol-generating material; wherein the device comprises a heating zone for receiving the consumable, and a magnetic field generator for generating a varying magnetic field for penetrating the susceptor when the consumable is in the heating zone, thereby to cause heating of the aerosol-generating material.

Optionally, the device is for causing heating of the aerosol-generating material of the consumable to volatilize at least one component of the aerosol-generating material without burning the aerosol-generating material.

Optionally, the susceptor comprises one or more materials selected from the group consisting of: an electrically-conductive material, a magnetic material, and a magnetic electrically-conductive material.

Optionally, the susceptor comprises a metal or a metal alloy.

Optionally, the susceptor comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

Optionally, the aerosol-generating material is a non-liquid material.

Optionally, the aerosol-generating material comprises tobacco.

Optionally, the aerosol-generating material comprises reconstituted aerosol-generating material, such as reconstituted tobacco.

Further features and advantages of the disclosure will become apparent from the following description of embodiments of the disclosure, given by way of example only, which is made with reference to the accompanying drawings.

### BRIEF DESCRIPTION OF THE DRAWINGS

Embodiments of the disclosure will now be described, by way of example only, with reference to accompanying drawings, in which:

FIG. 1 shows a schematic view of a susceptor according to an embodiment of the present disclosure.

FIG. 2 shows a flow chart of a method according to an embodiment of the present disclosure.

FIG. 3 shows a schematic view of a consumable according to an embodiment of the present disclosure.

FIG. 4 shows a flow chart of a method according to an embodiment of the present disclosure.

FIG. 5 shows a non-combustible aerosol provision system according to an embodiment of the present disclosure.

### DETAILED DESCRIPTION

As used herein, “aerosol-generating material” is material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional materials.

In some embodiments, the aerosol-generating material may comprise tobacco material, wherein tobacco material is any material comprising tobacco or derivatives thereof. The tobacco material may comprise one or more of ground tobacco, tobacco fibre, cut tobacco, extruded tobacco, tobacco stem, reconstituted tobacco and/or tobacco extract. In some embodiments, the aerosol-generating material may comprise a tobacco substitute.

As used herein, a “consumable” is an item comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use.

As used herein, a “susceptor” is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms.

When a susceptor is incorporated into a consumable, as heat is generated inside the consumable itself, rather than by an external heat source by heat conduction, a rapid temperature rise in the consumable and more uniform heat distribution can be achieved, particularly through the selection of suitable materials and geometry, and suitable varying magnetic field magnitude and orientation relative to the susceptor. Moreover, as induction heating and magnetic hysteresis heating do not require physical connection to be provided between the source of the varying magnetic field and the susceptor, material deposits on the susceptor, such as residue or condensate, may be less of an issue, design freedom and control over the heating profile may be greater, and cost may be lower.

When providing a susceptor within a consumable, it is possible that the susceptor may shift position in later use or may fall out of the consumable, which may occur due to movement of the consumable (e.g., before use) or during use as the susceptor heats-up.

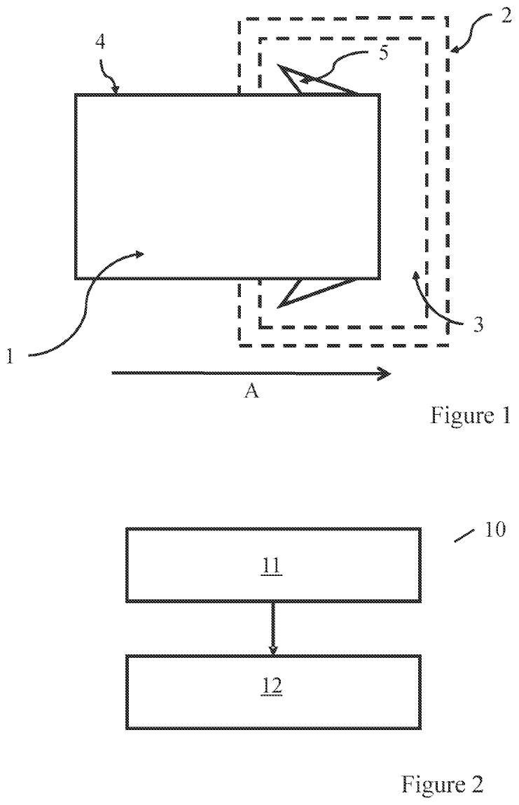

FIG. 1 shows a susceptor 1 according to one embodiment. The susceptor 1 is for embedding within an object 2 for use with a non-combustible aerosol provision device. The object 2 comprises aerosol-generating material 3. Upon application of a varying magnetic field, the susceptor 1 heats up and radiates heat to the area surrounding the susceptor 1. When the susceptor 1 is embedded within the object 2, such as within the aerosol-generating material 3 of the object 2, heat will be transferred from the susceptor 1 to the object 2 to facilitate volatilization of the aerosol-generating material 3.

In the embodiment of FIG. 1, the susceptor 1 is shaped to provide a lower resistance to movement of the susceptor 1 into the object 2 in a first direction (shown by arrow A) than out of the object 2 in a second direction opposite the first direction. Having a lower resistance to movement in the first direction than the second direction helps to prevent the susceptor 1 from being removed (whether intentionally or unintentionally) from the object 2 while still providing the ability to insert the susceptor 1 into the object 2.

In some embodiments, such as that of FIG. 1, the susceptor 1 comprises a body 4 and at least one projection 5 extending from the body 4. The at least one projection 5 may extend perpendicular from the body 4, or at any angle between zero degree and 180 degrees relative to the body 4, for example at an angle greater than zero degrees and less than 180 degrees relative to the body.

As shown in FIG. 1, the at least one projection 5 is arranged to engage with the object 2 when the susceptor 1 is at least partially embedded within the object 2. The at least one projection 5 provides resistance to movement of the susceptor 1 within the object 2. The at least one projection 5 is arranged to provide a lower resistance to movement of the susceptor 1 into the object 2 in the first direction A than out of the object 2 in the second direction (i.e., a direction substantially opposite to the first direction A).

In the embodiment shown in FIG. 1, each of the projections 5 comprises a barb. Each of the barbs provides increased resistance to movement of the susceptor 1 relative to the object 2 in the second direction. While the tip of the barb in FIG. 1 is shown as a point, it should be appreciated the tip may, in some implementations, be rounded, flattened or otherwise non-pointed.

In some embodiments, the body 4 is heatable by penetration with a varying magnetic field. In some embodiments, the or each projection 5 is heatable by penetration with a varying magnetic field.

As shown in FIG. 1, the body 4 is integrally formed with the or each projection 5. For example, the body 4 and the projections 5 may comprise a unitary item. In some embodiments, the body 4 and the at least one projection 5 may comprise the same material. This may reduce the cost of manufacturing and increase the ease of assembly. In some embodiments, the at least one projection 5 is separate from the body 4. The at least one projection 5 may be separately formed from the body 4 and subsequently attached to the body 4. The at least one projection 5 may take any form that allows, or at least does not prohibit, movement in the first direction A but resists or restricts movement in the second direction. For example, the at least one projection 5 may be biased such that the at least one projection 5 is unextended (i.e., does not project from the body 4) when the susceptor 1 moves in the first direction A and extends to resist movement when movement of the susceptor in the second direction is attempted. In some implementations, the projections 5 may be hinged or otherwise movably attached to the body 4 such that the projections may be selectively extended or non-extended as desired (e.g., via a suitable actuation mechanism, such as by magnetic attraction for example). This may provide the ability, in certain situations, for a user to remove the susceptor 1 from the object 2, if desired.

As shown in FIG. 1, more than one projection 5 may be provided. For example, in the embodiment shown in FIG. 1, two projections 5 are provided on opposite sides of the body 4. In some embodiments, the at least one projection 5 comprises more than two projections. At least a first of the plural projections extends from a first side of the body 4 and at least a second of the plural projections extends from a second side of the body 4 opposite from the first side of the body 4. It should be appreciated the projections 5 may, in some embodiments, extend above and/or below the plane of the susceptor 1 (i.e., into and/or out of the page of FIG. 1).

FIG. 2 shows a flow diagram of a method 10 of manufacturing a consumable for use with a non-combustible aerosol provision device, according to an embodiment.

The method 10 comprises providing 11 an object 2 and a susceptor 1, wherein the object 2 comprises aerosol-generating material 3. The object 2 may be the object 2 of FIG. 1 or any variant thereof discussed herein, for example. The susceptor 1 may be the susceptor 1 of FIG. 1 or any variant thereof discussed herein, for example. The method 10 also comprises moving 12 the susceptor 1 and the object 2 relative to each other so that the susceptor 1 is at least partially embedded within the object 2 in the first direction A.

In some embodiments, the object 2 comprises a rod comprising the aerosol-generating material 3 and a wrapper that is wrapped around the aerosol-generating material 3. In some embodiments the wrapper comprises paper. The object 2 itself may be made by any suitable method known in the art, such as by using a known rod maker, and so discussion thereof is omitted for brevity.

The object 2 may have any suitable shape, such as cylindrical or polygonal. A cross-sectional shape of the object 2 may be circular, elliptical, or polygonal, for example. Similarly, the consumable could have any suitable shape for use with a non-combustible aerosol provision device, such as cylindrical or polygonal. A cross-sectional shape of the consumable may be circular, elliptical, or polygonal, for example.

In some embodiments, the moving 12 comprises pushing the susceptor 1 into the object 2 in the first direction A. Alternatively, the moving 12 may comprise pulling the susceptor 1 into the object 2 in the first direction A.

In some embodiments, the moving 12 comprises moving the susceptor 1 and the object 2 relative to each other so that the susceptor 1 is at least partially embedded within the aerosol-generating material 3 of the object in the first direction A.

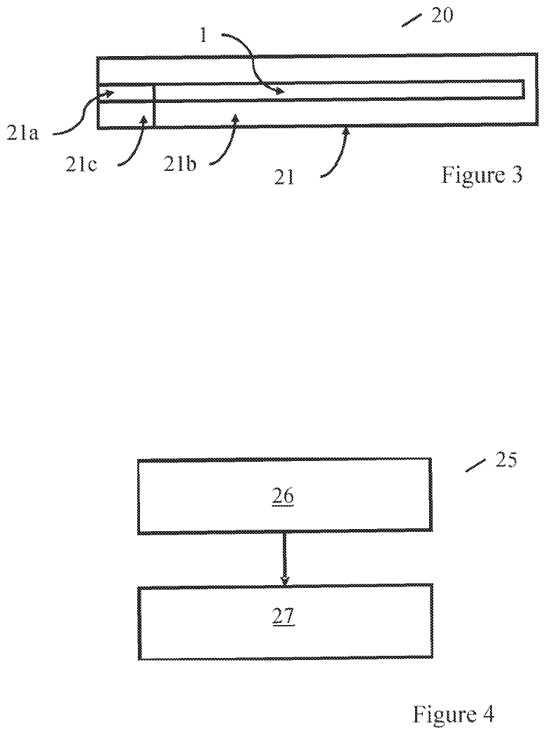

FIG. 3 shows a schematic view of a consumable 20 for use with a non-combustible aerosol provision device, according to one embodiment. The consumable 20 comprises aerosol-generating material 21 and a susceptor 1 at least partially embedded in the aerosol-generating material 21. The susceptor 1 may be the susceptor of FIG. 1 or any variant thereof discussed herein, for example.

In some embodiments, the susceptor 1 is at least partially embedded in the aerosol-generating material 21. For example, as shown in FIG. 3, the susceptor 1 is fully embedded in the aerosol-generating material 21.

In some embodiments, such as that of FIG. 3, the susceptor 1 is at least partially embedded in the aerosol-generating material 21 so that a first potion of the aerosol-generating material 21a is axially adjacent the susceptor 1. A density of the first portion of the aerosol-generating material 21a and/or a density of a second portion of the aerosol-generating material 21b radially adjacent the susceptor 1 is greater than a density of a third portion of the aerosol-generating material 21c radially adjacent the first portion of the aerosol-generating material 21a.

In some embodiments, the (average) density of the first portion of the aerosol-generating material 21a and the (average) density of the second portion of the aerosol-generating material 21b are each separately greater than the (average) density of the third portion of the aerosol-generating material 21c. Accordingly, regions of aerosol-generating material with relatively higher average densities are found (directly) adjacent the susceptor 1. Accordingly, these regions have more closely packed aerosol-generating material which may help improve the transfer of heat from the susceptor to the aerosol-generating material to generate aerosol. In some implementations, these densities of aerosol-generating material 21 of the consumable 20 including the susceptor 1 may result from careful and appropriate selection of associated densities of aerosol-generating material 21 in the different portions 21a, 21b, 21c before insertion of the susceptor 1 in the manner described herein. The first and second portions of the aerosol-generating material 21a, 21b are adjacent the susceptor 1 and will therefore be subject to higher temperatures from the susceptor 1 than the third portion of the aerosol-generating material 21c. In contrast, relatively little aerosol may be generatable from the third portion 21c. Therefore, providing the first and second portion(s) 21a, 21b of the aerosol-generating material 21 with the relatively higher densities may enable more plentiful and/or rapid generation of aerosol from the aerosol-generating material 21, while reducing the overall amount of aerosol-generating material 21 that need be included in the consumable 20.

FIG. 4 shows a flow chart of a method 25 of manufacturing a consumable for use with a non-combustible aerosol provision device. The method 25 comprises providing an object 26 comprising aerosol-generating material 3. The aerosol-generating material 3 comprises a first portion of aerosol generating material 21a, a second portion of aerosol-generating material 21b and a third portion of aerosol-generating material 21c. A density of the first portion of the aerosol-generating material 21a and/or a density of the second portion of the aerosol-generating material 21b is greater than a density of the third portion of the aerosol-generating material 21c. The method 25 further comprises embedding a susceptor 27 at least partially in the aerosol-generating material 3 so that the first portion of the aerosol-generating material 21a is axially adjacent the susceptor 1, the second portion of the aerosol-generating material 21b is radially adjacent the susceptor 1 and the third portion of the aerosol-generating material 21c is radially adjacent the first portion of the aerosol generating-material 21a. In some embodiments, the consumable 20 of FIG. 3 is manufactured according to the method 25 of FIG. 4.

In some embodiments, an axial dimension of the susceptor 1 is less than a parallel dimension of the bulk aerosol-generating material 21 (that is, the region of the consumable 20 containing the aerosol-generating material). As shown by way of example in FIG. 3, the susceptor 1 may be fully embedded in the aerosol-generating material 21. Fully embedding the susceptor 1 in the aerosol-generating material 21 helps to ensure that all of the heat generated by the susceptor 1 is within the aerosol-generating material 21. This may increase efficiency of the heating. Moreover, this arrangement can help avoid a user coming into direct contact with the susceptor 1 when it is hot. Alternatively, the susceptor 1 may be partially embedded within the aerosol-generating material 21 such that a part of the susceptor 1 protrudes from the aerosol-generating material 21 or is visible at a surface of the aerosol-generating material 21.

In some embodiments, as shown by way of example in FIG. 3, the susceptor 1 is coaxial with a central axis of the consumable 20. This allows for heat to be radiated outwardly away from the susceptor 1 and uniformly heat the surrounding aerosol-generating material 21. Alternatively, the susceptor 1 may be positioned in any other position relative to the central axis of the consumable 20 that allows heating of the aerosol-generating material 21.

In some embodiments, the susceptor 1 comprises one or more materials selected from the group consisting of: an electrically-conductive material, a magnetic material, and a magnetic electrically-conductive material. In some embodiments, the susceptor 1 comprises a metal or a metal alloy. In some embodiments, the susceptor 1 comprises one or more materials selected from the group consisting of: aluminum, gold, iron, nickel, cobalt, conductive carbon, graphite, steel, plain-carbon steel, mild steel, stainless steel, ferritic stainless steel, molybdenum, silicon carbide, copper, and bronze.

In some embodiments, the aerosol-generating material 3, 21 is a non-liquid material. In some embodiments, the aerosol-generating material 3, 21 comprises tobacco. In some embodiments, the aerosol-generating material 3, 21 comprises reconstituted aerosol-generating material, such as reconstituted tobacco.

In some embodiments, the object may be the consumable. For example, while in some embodiments, further manufacturing steps are made to the object to form the consumable (such as providing a filter), in other embodiments no further manufacturing steps are necessary to form the consumable from the object once the susceptor has been inserted.

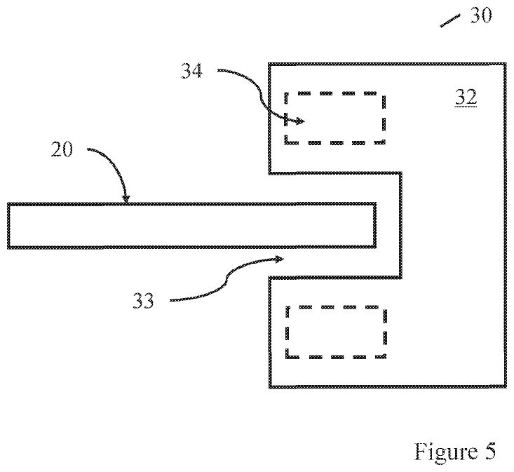

FIG. 5 shows a schematic view of a non-combustible aerosol provision system 30 according to one embodiment. The non-combustible aerosol provision system 30 comprises a consumable 20. The consumable 20 may be consumable 20 of FIG. 3, object 2 of FIG. 1, or any variant thereof disclosed herein, for example. The non-combustible aerosol provision system 30 also comprises a non-combustible aerosol provision device 32 for causing heating of the aerosol-generating material 21 of the consumable 20 to volatilize at least one component of the aerosol-generating material 21. The device 32 comprises a heating zone 33 for receiving the consumable 20 and a magnetic field generator 34 for generating a varying magnetic field for penetrating the susceptor 1 when the consumable 20 is in the heating zone 33, thereby causing heating of the aerosol-generating material.

In some embodiments, the device 32 is for causing heating of the aerosol-generating material 21 of the consumable 20 to volatilize at least one component of the aerosol-generating material 21 without burning the aerosol-generating material 21. In some embodiments, the device 32 may be a tobacco heating device, also known as a tobacco heating product.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure.

1. A susceptor for at least partially embedding within an object for use with a non-combustible aerosol provision device, the object comprising aerosol-generating material;
wherein the susceptor is shaped to provide a lower resistance to movement of the susceptor into the object in a first direction than out of the object in a second direction opposite to the first direction.

2. The susceptor of claim 1, comprising a body and at least one projection extending from the body;
wherein the at least one projection is arranged to engage with the object when the susceptor is embedded within the object to provide a resistance to movement of the susceptor within the object; and
wherein the at least one projection is arranged to provide a lower resistance to movement of the susceptor into the object in the first direction than out of the object in the second direction.

3. The susceptor of claim 2, wherein the or each projection comprises a barb.

4. The susceptor of claim 2, wherein the body is heatable by penetration with a varying magnetic field.

5. The susceptor of claim 2, wherein the or each projection is heatable by penetration with a varying magnetic field.

6. The susceptor of claim 2, wherein the body is integrally formed with the or each projection.

7. The susceptor of claim 2, wherein the at least one projection comprises plural projections, wherein at least a first of the plural projections extends from a first side of the body, and wherein at least a second of the plural projections extends from a second side of the body opposite from the first side of the body.

8. A method of manufacturing a consumable for use with a non-combustible aerosol provision device, the method comprising:
providing an object and a susceptor shaped to provide a lower resistance to movement of the susceptor into the object in a first direction than out of the object in a second direction opposite to the first direction, wherein the object comprises aerosol-generating material; and
moving the susceptor and the object relative to each other so that the susceptor is at least partially embedded within the object in the first direction.

9. The method of claim 8, wherein the object comprises a rod comprising the aerosol-generating material and a wrapper that is wrapped around the aerosol-generating material.

10. The method of claim 8, wherein the moving comprises pushing the susceptor into the object in the first direction.

11. The method of claim 8, wherein the moving comprises moving the susceptor and the object relative to each other so that the susceptor is at least partially embedded within the aerosol-generating material in the first direction.

12. A consumable for use with a non-combustible aerosol provision device, the consumable comprising an object comprising aerosol-generating material, and a susceptor shaped to provide a lower resistance to movement of the susceptor into the object in a first direction than out of the object in a second direction opposite to the first direction at least partially embedded in the object.

13. The consumable of claim 12, wherein the susceptor is at least partially embedded in the aerosol-generating material.

14. The consumable of claim 13, wherein the susceptor is shaped to provide a lower resistance to movement of the susceptor into the aerosol-generating material of the object in a first direction than out of the aerosol-generating material of the object in a second direction opposite to the first direction.

15. A consumable for use with a non-combustible aerosol provision device, the consumable comprising:
aerosol-generating material, and
a susceptor that is at least partially embedded in the aerosol-generating material so that a first portion of the aerosol-generating material is axially adjacent the susceptor;
wherein a density of the first portion of the aerosol-generating material and/or a density of a second portion of the aerosol-generating material radially adjacent the susceptor is greater than a density of a third portion of the aerosol-generating material radially adjacent the first portion of the aerosol generating-material.

16. The consumable of claim 15, wherein the density of the first portion of the aerosol-generating material and the density of the second portion of the aerosol-generating material are greater than the density of the third portion of the aerosol-generating material.

17. The consumable of claim 15, wherein an axial dimension of the susceptor is less than a parallel dimension of the aerosol-generating material.

18. The consumable of claim 12, wherein the susceptor is fully embedded in the aerosol-generating material.

19. The consumable of claim 12, wherein the susceptor is substantially coaxial with a central axis of the consumable.

20. A method of manufacturing a consumable for use with a non-combustible aerosol provision device, the method comprising:
providing an object comprising aerosol-generating material, the aerosol-generating material comprising:
a first portion of aerosol-generating material, a second portion of aerosol-generating material and a third portion of aerosol-generating material,
wherein a density of the first portion of the aerosol-generating material and/or a density of the second portion of the aerosol-generating material is greater than a density of the third portion of the aerosol-generating material; and
embedding a susceptor at least partially in the aerosol-generating material so that the first portion of the aerosol-generating material is axially adjacent the susceptor, the second portion of the aerosol-generating material is radially adjacent the susceptor and the third portion of the aerosol-generating material is radially adjacent the first portion of the aerosol generating-material.

21. A consumable manufactured by:
providing an object comprising aerosol-generating material, the aerosol-generating material comprising:
a first portion of aerosol-generating material, a second portion of aerosol-generating material and a third portion of aerosol-generating material,
wherein a density of the first portion of the aerosol-generating material and/or a density of the second portion of the aerosol-generating material is greater than a density of the third portion of the aerosol-generating material; and
embedding a susceptor at least partially in the aerosol-generating material so that the first portion of the aerosol-generating material is axially adjacent the susceptor, the second portion of the aerosol-generating material is radially adjacent the susceptor and the third portion of the aerosol-generating material is radially adjacent the first portion of the aerosol generating-material.

22. The consumable of claim 15 wherein the susceptor is shaped to provide a lower resistance to movement of the susceptor into the object in a first direction than out of the object in a second direction opposite to the first direction.

23. A non-combustible aerosol provision system, comprising:
a consumable comprising an object comprising aerosol-generating material, and a susceptor shaped to provide a lower resistance to movement of the susceptor into the object in a first direction than out of the object in a second direction opposite to the first direction at least partially embedded in the object; and
a non-combustible aerosol provision device for causing heating of the aerosol-generating material of the consumable to volatize at least one component of the aerosol-generating material;
wherein the device comprises a heating zone for receiving the consumable, and a magnetic field generator for generating a varying magnetic field for penetrating the susceptor when the consumable is in the heating zone, thereby to cause heating of the aerosol-generating material.

24. The system of claim 23, wherein the device is for causing heating of the aerosol-generating material of the consumable to volatize at least one component of the aerosol-generating material without burning the aerosol-generating material.
